(19) United States
(12) Patent Application Publication
(10) Pub. No.: US 2025/0314616 A1
(43) Pub. Date: Oct. 9, 2025

(54) ANALYSIS DEVICE AND ANALYSIS SYSTEM

(71) Applicant: GeneMind Biosciences Co., Ltd., Shenzhen (CN)

(72) Inventors: Penglei Wang, Shenzhen (CN); Guangming Wang, Shenzhen (CN); Yang Li, Shenzhen (CN); Jiasheng Li, Shenzhen (CN); Ping Wu, Shenzhen (CN); Zhiliang Zhou, Shenzhen (CN)

(21) Appl. No.: 19/173,051

(22) Filed: Apr. 8, 2025

(30) Foreign Application Priority Data
Apr. 9, 2024 (CN) CN202410423535.3

(51) Int. Cl. G01N 27/447; G01N 35/00

(52) U.S. Cl. CPC G01N 27/44791; G01N 27/44721; G01N 35/0099

(57) ABSTRACT

Provided are an analysis device and an analysis system. The analysis device includes a baseplate; a chip fixing mechanism disposed on the baseplate; an electrophoresis mechanism disposed on the baseplate and an imaging mechanism disposed on the baseplate; and a blocking mechanism disposed in a first cavity and corresponding to a position of an analysis station. When a chip is located at the analysis station, the chip fixing mechanism fixes the chip, the blocking mechanism prevents the chip from falling, the electrophoresis mechanism performs electrophoretic separation on samples to be analyzed in the chip, the imaging mechanism captures images of the samples to be analyzed, and finally the chip fixing mechanism releases the chip and the blocking mechanism moves so that the chip falls to a recovery station. The chip is recovered in a falling manner, and a moving mechanism for driving the chip to move does not need to be designed, achieving a simple structure and a low cost; moreover, the chip falls from top to bottom, fully utilizing a spare space under the device, avoiding the addition of unnecessary horizontal space occupied, and reducing the overall volume of the device.

### TECHNICAL FIELD

The present invention relates to the field of bioanalysis technology and, in particular, to an analysis device and an analysis system.

### BACKGROUND

The subject matter discussed in this part is not to be considered as the existing art simply because it is mentioned in this part. Similarly, any technical problems mentioned in this part or associated with the subject matter provided as the background are not to be considered as having been previously recognized in the existing art.

Various types of analyzers for analyzing samples containing DNA, RNA, or proteins by an electrophoresis method are available on the market.

An existing analyzer needs to be provided with a moving mechanism such as a grabbing robotic arm. The grabbing robotic arm grabs a waste chip subjected to electrophoresis and capturing, moves the waste chip to above a waste bin, and releases the waste chip so that the waste chip falls into the waste bin. The moving mechanism is complex in structure and high in cost. Moreover, additional horizontal space is required for use as an activity space of the moving mechanism and for placing the waste bin so that the moving mechanism smoothly discards the waste chip into the waste bin, resulting in a significant increase in the overall space occupied by the analyzer.

### SUMMARY

To solve at least one of the preceding technical problems to at least some extent or to provide a practical commercial means, embodiments of the present invention provide an analysis device and an analysis system.

An analysis device of an embodiment of the present invention includes a baseplate provided with a first cavity; a chip fixing mechanism disposed on the baseplate and including at least one analysis station located in the first cavity; an electrophoresis mechanism disposed on the baseplate and an imaging mechanism disposed on the baseplate; and a blocking mechanism disposed in the first cavity, corresponding to a position of an analysis station among the at least one analysis station, and including at least one recovery station.

When a chip is located at the analysis station, the chip fixing mechanism fixes the chip, the blocking mechanism prevents the chip from falling, the electrophoresis mechanism performs electrophoretic separation on samples to be analyzed in the chip, the imaging mechanism captures images of the samples to be analyzed, and finally the chip fixing mechanism releases the chip and the blocking mechanism moves so that the chip falls to a recovery station among the at least one recovery station.

In the analysis device of the embodiment of the present invention, the chip is placed at the analysis station of the chip fixing mechanism, the chip fixing mechanism fixes the chip, the blocking mechanism blocks the chip and prevents the chip from falling, the electrophoresis mechanism performs the electrophoretic separation on the samples to be analyzed in the chip, and the imaging mechanism captures the images of the samples to be analyzed. After the analysis of the samples to be analyzed, the chip fixing mechanism releases the chip and the blocking mechanism moves so that the chip falls to the recovery station, thereby recovering waste chip. The chip is recovered in a falling manner, and a moving mechanism for driving the chip to move does not need to be designed, achieving a simple structure and a low cost; moreover, the chip falls from top to bottom, fully utilizing a spare space under the device, avoiding the addition of unnecessary horizontal space occupied, and reducing the overall volume of the device.

An analysis system of an embodiment of the present invention includes the analysis device according to any one of the preceding embodiments and at least one chip vertically placed on the chip fixing mechanism.

Additional aspects and advantages of the embodiments of the present invention are set forth in part in the following description and become apparent in part from the following description or may be learned through the practice of the embodiments of the present invention.

### BRIEF DESCRIPTION OF DRAWINGS

The preceding and/or additional aspects and advantages of embodiments of the present invention become apparent and easily understood from a description of the embodiments in conjunction with the drawings below.

FIG. 1 is a schematic view of an analysis device according to an embodiment of the present invention.

FIG. 2 is a partial enlarged view of part A of FIG. 1 according to an embodiment of the present invention.

FIG. 3 is a schematic view of an analysis device according to an embodiment of the present invention from another angle.

FIG. 4 is a partial enlarged view of part B of FIG. 3 according to an embodiment of the present invention.

FIG. 5 is a schematic view of a baffle according to an embodiment of the present invention.

FIG. 6 is a schematic view of an electrophoretic fixing plate according to an embodiment of the present invention.

FIG. 7 is a schematic view of a fixing plate according to an embodiment of the present invention.

FIG. 8 is a schematic view showing movements of a pushing member and a baffle according to an embodiment of the present invention.

FIG. 9 is a schematic view of an imaging mechanism according to an embodiment of the present invention.

FIG. 10 is a schematic view of a sample loading mechanism according to an embodiment of the present invention.

FIG. 11 is a partial enlarged view of part C of FIG. 10 according to an embodiment of the present invention.

FIG. 12 is a schematic view of a chip according to an embodiment of the present invention.

FIG. 13 is a schematic view of a substrate of a chip according to an embodiment of the present invention.

FIG. 14 is a partial enlarged view of part D of FIG. 13 according to an embodiment of the present invention.

### DETAILED DESCRIPTION

Embodiments of the present application are described in detail below, where examples of the embodiments are shown in the accompanying drawings. The embodiments described below with reference to the drawings are exemplary and intended to explain the present application and cannot be construed as limiting the present application.

In the process of describing the present application, relevant terms are explained and described only for facilitating an understanding of solutions, and the explanations and descriptions cannot be construed as limiting the solutions protected in the present application.

Unless otherwise specified herein, the singular forms “a”, “an”, etc. include plural referents (more than one); and “a group” or “multiple” refers to two or more.

Unless otherwise specified herein, the term “comprising” or “including” is open and does not exclude other contents or cases not listed or illustrated here, which are consistent with what is described here.

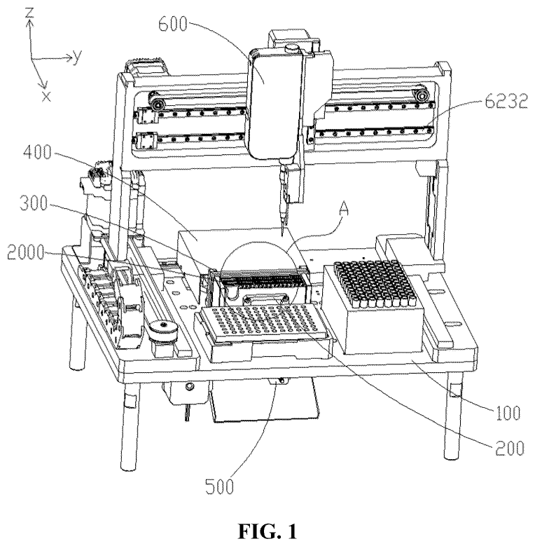

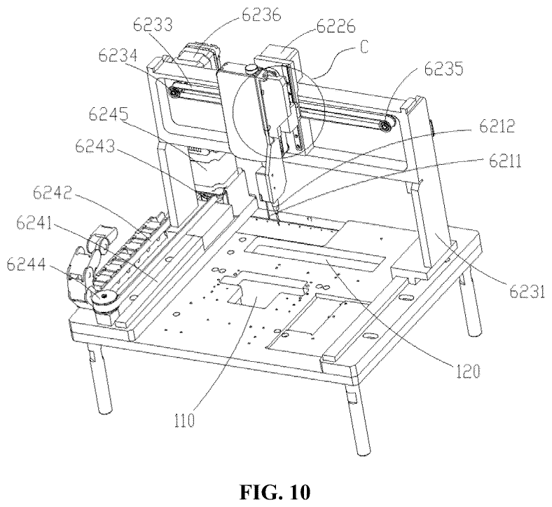

An embodiment of the present invention provides an analysis device. Referring to FIGS. 1 and 10, the analysis device includes a baseplate 100, a chip fixing mechanism 200, an electrophoresis mechanism 300, an imaging mechanism 400, and a blocking mechanism 500.

The baseplate 100 is provided with a first cavity 110.

The chip fixing mechanism 200 is disposed on the baseplate 100 and includes at least one analysis station located in the first cavity 110.

The electrophoresis mechanism 300 and the imaging mechanism 400 are disposed on the baseplate 100.

The blocking mechanism 500 is disposed in the first cavity 110, corresponds to a position of the analysis station, and includes at least one recovery station.

When a chip 2000 is located at the analysis station, the chip fixing mechanism 200 fixes the chip 2000, the blocking mechanism 500 prevents the chip 2000 from falling, the electrophoresis mechanism 300 performs electrophoretic separation on samples to be analyzed in the chip 2000, the imaging mechanism 400 captures images of the samples to be analyzed, and finally the chip fixing mechanism 200 releases the chip 2000 and the blocking mechanism 500 moves so that the chip 2000 falls to the recovery station.

The baseplate 100 is designed to have a rectangular structure, and the chip fixing mechanism 200, the electrophoresis mechanism 300, the imaging mechanism 400, and the blocking mechanism 500 are disposed on the baseplate 100. Multiple support legs are disposed under the lower surface of the baseplate 100, and the support legs support the baseplate 100.

The chip 2000 may be directly placed at the analysis station of the chip fixing mechanism 200. Alternatively, the chip 2000 may be placed at an entrance of the analysis device, and the chip 2000 at the entrance is moved to the analysis station of the chip fixing mechanism 200 by a moving mechanism such as a robotic arm or a conveyor belt. The chip 2000 may be placed vertically. The chip 2000 may be directly placed vertically at the analysis station of the chip fixing mechanism 200. Alternatively, the chip 2000 may be placed vertically at the entrance of the analysis device, and the chip 2000 at the entrance is moved to the analysis station of the chip fixing mechanism 200 by the moving mechanism. Alternatively, the chip 2000 may be placed horizontally. The chip 2000 may be directly placed horizontally at the analysis station of the chip fixing mechanism 200. Alternatively, the chip 2000 may be placed horizontally at the entrance of the analysis device, and the chip 2000 at the entrance is moved to the analysis station of the chip fixing mechanism 200 by the moving mechanism.

When the chip 2000 is at the analysis station, the chip fixing mechanism 200 fixes the chip 2000 to prevent the chip 2000 from moving during the subsequent electrophoretic separation and imaging of the chip 2000. At this time, the blocking mechanism 500 is at an initial position and can block the chip 2000 and prevent the chip 2000 from falling.

After the chip fixing mechanism 200 fixes the chip 2000, the electrophoresis mechanism 300 performs the electrophoretic separation on the samples to be analyzed in the chip 2000. After the electrophoretic separation, the imaging mechanism 400 captures the images of the samples to be analyzed and then analyzes the captured images to obtain information about the samples to be analyzed, such as fragment lengths, concentrations, and integrity.

After the analysis, the chip fixing mechanism 200 releases the chip 2000 and no longer fixes the chip 2000, allowing the chip 2000 to move. The blocking mechanism 500 moves from the initial position, and the chip 2000 falls to the recovery station when not blocked by the blocking mechanism 500.

After one chip 2000 is analyzed and recovered, the next chip 2000 is subjected to the preceding operations until all chips 2000 are analyzed and recovered.

In some embodiments, one analysis station is provided. When the chip 2000 is at the analysis station, the chip fixing mechanism 200 fixes the chip 2000, the electrophoresis mechanism 300 performs the electrophoretic separation on the chip, the imaging mechanism 400 captures the images of the chip 2000, and finally the chip fixing mechanism 200 releases the chip 2000 and the blocking mechanism 500 moves so that the chip falls to the recovery station.

In some embodiments, multiple analysis stations are provided, multiple recovery stations are provided, and the recovery stations correspond to the analysis stations one to one. When multiple chips 2000 are at the analysis stations one to one, the chip fixing mechanism 200 fixes the multiple chips 2000, the electrophoresis mechanism 300 performs the electrophoretic separation on the multiple chips 2000 one by one or simultaneously, the imaging mechanism 400 captures images of the multiple chips 2000 one by one or simultaneously, and finally the chip fixing mechanism 200 releases the multiple chips 2000 and the blocking mechanism 500 moves so that the multiple chips 2000 fall into the corresponding recovery stations.

The analysis device provided in the present invention can perform electrophoretic analysis on samples containing biological substances such as DNA, RNA, or proteins by using electrophoresis technology. Herein, “sample” and “sample to be analyzed” have the same meaning and both refer to a sample loaded into the chip 2000 and to be analyzed.

For example, for nucleic acid samples containing DNA or RNA, when the chip 2000 is at the analysis station, the chip fixing mechanism 200 fixes the chip 2000, the electrophoresis mechanism 300 applies voltages across the nucleic acid samples in the chip 2000, and the nucleic acid samples move under the action of electric fields. Since the nucleic acid samples contain nucleic acid fragments of different lengths, the nucleic acid fragments of different lengths are separated at different speeds and form multiple bands. After the nucleic acid samples are subjected to the electrophoretic separation, the imaging mechanism 400 captures images of the nucleic acid samples and analyzes the captured images to obtain the length, concentration, and integrity and other information of a nucleic acid fragment corresponding to each band of the nucleic acid samples. After the analysis, the chip fixing mechanism 200 releases the chip 2000 and the blocking mechanism 500 moves so that the chip 2000 falls to the recovery station. For samples containing other biological substances, the electrophoresis mechanism 300 may also perform the electrophoretic separation, and the imaging mechanism 400 may also capture images and analyze the captured images to complete the analysis.

Further, the nucleic acid samples are loaded with a molecular weight standard (ladder). The nucleic acid samples and the molecular weight standard are subjected to the electrophoretic separation under the action of the electric fields. During the subsequent analysis according to the obtained images, bands separated from the molecular weight standard are used for reference, the bands separated from the molecular weight standard are compared with bands separated from the nucleic acid samples, and the lengths, concentrations, and nucleic acid integrity indexes of the nucleic acid fragments corresponding to the bands separated from the nucleic acid samples are calculated. Of course, it is also possible to directly calculate the lengths, concentrations, and nucleic acid integrity indexes of the nucleic acid fragments corresponding to the bands separated from the nucleic acid samples according to the bands of the nucleic acid samples after the electrophoretic separation, without loading the molecular weight standard into the nucleic acid samples.

In the analysis device provided in the present invention, the chip 2000 is recovered in a falling manner, and a moving mechanism for driving the chip 2000 to move to the recovery station does not need to be designed, achieving a simple structure and a low cost; moreover, the chip 2000 falls from top to bottom, fully utilizing a spare space under the device, avoiding the addition of unnecessary horizontal space occupied, and reducing the overall volume of the device.

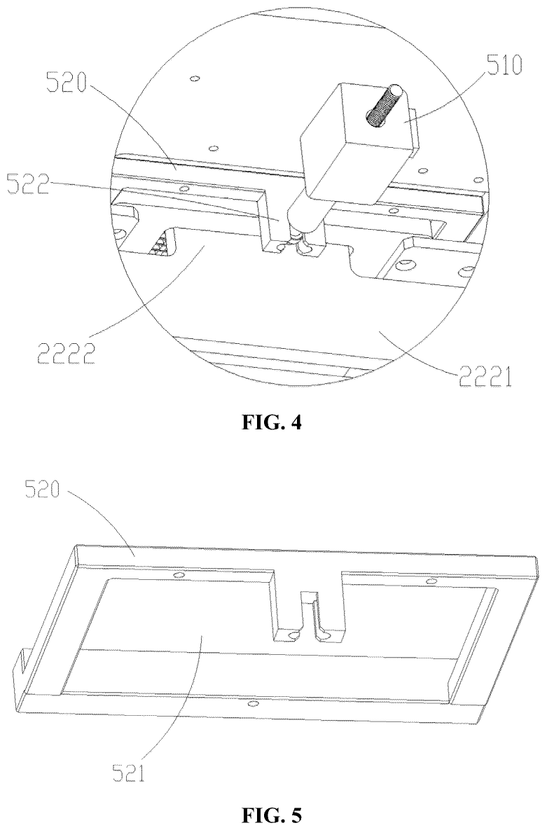

In some specific embodiments of the present application, referring to FIGS. 1 to 5, the blocking mechanism 500 includes a baffle 520 and a first drive 510.

The baffle 520 is disposed in the first cavity 110 and corresponds to the position of the analysis station.

The first drive 510 is drivingly connected to the baffle 520.

The first drive 510 may drive the baffle 520 to move. For example, the first drive 510 is an electric motor, the baffle 520 is provided with a protrusion 522, and an output shaft of the electric motor is connected to the protrusion 522. When the electric motor operates, the output shaft drives the protrusion 522 to move, thereby driving the baffle 520 to move.

To save space, the first drive 510 is disposed under the baseplate 100.

The baffle 520 is designed to have a rectangular structure. No matter whether the chip 2000 is placed vertically or horizontally at the analysis station, the baffle 520 can prevent the chip 2000 from falling. After the baffle 520 moves, the chip 2000 can fall to the recovery station when not blocked by the baffle 520.

The baffle 520 is disposed in the first cavity 110, and a horizontal surface of the baffle 520 is flush with the first cavity 110 so that during movement, the chip 2000 does not contact an uneven plane and can smoothly move.

When the chip 2000 is placed at the analysis station, the baffle 520 is at the initial position and can block the chip 2000 and prevent the chip 2000 from falling. After the chip 2000 is analyzed, the first drive 510 drives the baffle 520 to move, and the chip 2000 falls to the recovery station when not blocked by the baffle 520.

In some specific embodiments of the present application, referring to FIGS. 1 and 3, the blocking mechanism 500 further includes a bending plate 530 having a certain bending angle, disposed in the first cavity 110, and corresponding to the position of the analysis station. When the chip 2000 falls, the chip 2000 falls to the recovery station along the bending plate 530.

Through holes are provided on two sides of the bending plate 530. Screws penetrate through the through holes so that the bending plate 530 can be fixedly connected to an inner wall of the first cavity 110.

The bending plate 530 is made of a material that is not easy to deform, such as iron, steel, or an aluminum alloy.

The bending plate 530 includes a first surface and a second surface, where a certain bending angle, such as 50°, 60°, or 70°, is formed between the first surface and the second surface. After the samples to be analyzed in the chip 2000 are analyzed, the first drive 510 drives the baffle 520 to move, and the chip 2000 starts to fall when not blocked by the baffle 520. The chip 2000 falls onto the first surface and then falls to the recovery station along the first surface and the second surface, or the chip 2000 falls onto the second surface and then falls to the recovery station along the second surface.

The bending plate 530 can implement a certain guiding function and prevent the chip 2000 from failing to fall smoothly to the recovery station. Moreover, the bending plate 530 can implement a certain buffer function and prevent damages to the chip 2000 and the leakage of a sample to be analyzed in the chip 2000 when the chip 2000 falls to the recovery station from top to bottom.

In some specific embodiments of the present application, a waste bin is provided at the recovery station. After the samples to be analyzed in the chip 2000 are analyzed, the blocking mechanism 500 moves, and the chip 2000 falls into the waste bin at the recovery station. After all the chips 2000 are analyzed or after a certain period, a user may recover the analyzed chips 2000 from the waste bin.

In some specific embodiments of the present application, referring to FIGS. 1 to 4, the chip fixing mechanism 200 includes a fixing plate 210 and a pushing mechanism.

The fixing plate 210 is disposed on the baseplate 100.

The pushing mechanism provides a thrust towards the chip 2000 placed on the fixing plate 210, where being pushed by the pushing mechanism, the chip 2000 abuts against the fixing plate 210.

The fixing plate 210 is fixedly disposed on the baseplate 100. The chip 2000 is vertically positioned. Being pushed by the pushing mechanism, the chip 2000 abuts against the fixing plate 210. One chip 2000 may be provided, where a side of the chip 2000 is subjected to the thrust from the pushing mechanism and the other side of the chip 2000 is subjected to a force from the fixing plate 210. Multiple chips 2000 may be provided, where the chips 2000 are adhered to each other, one chip 2000 in contact with the pushing mechanism is subjected to the thrust from the pushing mechanism, and another chip 2000 in contact with the fixing plate 210 abuts against the fixing plate 210 when pushed by the pushing mechanism.

When the chip 2000 is initially at the analysis station, the chip 2000 may be slightly inclined. The pushing mechanism provides the thrust for the chip 2000. Subjected to the thrust from one side and the force of the fixing plate 210 from the other side, the chip 2000 slightly rotates to become vertical and abut against the fixing plate 210.

When one chip 2000 is provided, the chip 2000 is placed vertically, one side of the chip 2000 receives the thrust from the pushing mechanism, and the other side of the chip 2000 abuts against the fixing plate 210. After the samples to be analyzed in the chip 2000 are analyzed, the pushing mechanism moves, and the chip 2000 loses the thrust from the pushing mechanism and is released. The blocking mechanism 500 moves so that the chip 2000 falls to the recovery station. Then, the next chip 2000 is placed for analysis and recovery.

When multiple chips 2000 are provided, the multiple chips 2000 are placed vertically, the pushing mechanism provides the thrust for the chip 2000 in contact with the pushing mechanism, and the fixing plate 210 provides the force for the chip 2000 in contact with the fixing plate 210. The chips 2000 abut against each other, and the chip 2000 adjacent to the fixing plate 210 is at the analysis station. After the samples to be analyzed in the chip 2000 at the analysis station are analyzed, the pushing mechanism moves, the chip 2000 at the analysis station is released, and the blocking mechanism 500 moves so that the chip 2000 at the analysis station falls to the recovery station. The blocking mechanism 500 moves to reset, and the pushing mechanism moves again so that the remaining chips 2000 abut against each other, and the next chip 2000 moves to the analysis station. The preceding operations are repeated so that the next chip 2000 is also analyzed and recovered. After all the chips 2000 are analyzed and recovered, the next batch of chips 2000 is placed for analysis and recovery.

In other embodiments, the chip fixing mechanism 200 may have other designed structures. For example, the chip fixing mechanism 200 is a clamp. When the chip 2000 is at the analysis station, the clamp holds the chip 2000 tightly so that the chip 2000 is fixed. After the chip 2000 is analyzed, the clamp releases the chip 2000, and the blocking mechanism 500 moves so that the chip 2000 at the analysis station falls to the recovery station.

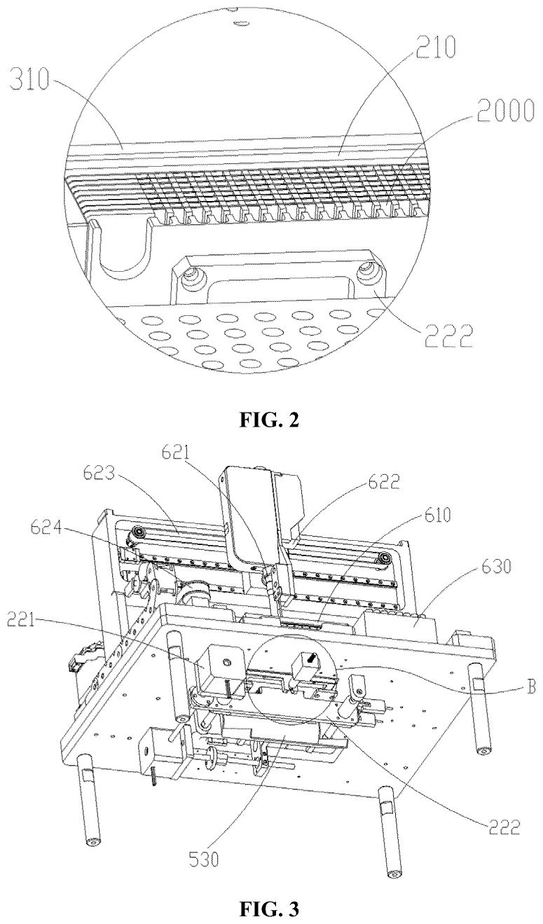

In some specific embodiments of the present application, referring to FIGS. 2 to 4, the pushing mechanism includes a second drive 221 and a pushing member 222.

The second drive 221 is disposed under the baseplate 100.

The pushing member 222 includes a transverse plate 2221 and an upright plate 2222, where the transverse plate 2221 is drivingly connected to the second drive 221, an end of the upright plate 2222 is fixedly connected to the transverse plate 2221, and the other end of the upright plate 2222 penetrates through the first cavity 110 and contacts the chip 2000 placed on the fixing plate 210.

The second drive 221 may drive the pushing member 222 to move. For example, the second drive 221 is an electric motor, and an output shaft of the electric motor is connected to the transverse plate 2221. When the electric motor operates, the output shaft drives the transverse plate 2221 to move, thereby driving the whole pushing member 222 to move. The pushing member 222 provides the thrust for the chip 2000 in contact with the pushing member 222.

To save space, the second drive 221 is disposed under the baseplate 100.

When the chip 2000 is initially at the analysis station, the chip 2000 may be slightly inclined. The second drive 221 drives the pushing member 222 to move, and the pushing member 222 provides the thrust for the chip 2000. Subjected to the thrust from one side and the force of the fixing plate 210 from the other side, the chip 2000 slightly rotates to become vertical and abut against the fixing plate 210.

When one chip 2000 is provided, the chip 2000 is placed vertically, the second drive 221 drives the pushing member 222 to move so that one side of the chip 2000 receives the thrust from the pushing member 222, and the other side of the chip 2000 abuts against the fixing plate 210. After the samples to be analyzed in the chip 2000 are analyzed, the second drive 221 drives the pushing member 222 to move, and the chip 2000 loses the thrust from the pushing member 222 and is released. The blocking mechanism 500 moves so that the chip 2000 falls to the recovery station. Then, the next chip 2000 is placed for analysis and recovery.

When multiple chips 2000 are provided, the multiple chips 2000 are placed vertically, the second drive 221 drives the pushing member 222 to move, the pushing member 222 provides the thrust for the chip 2000 in contact with the pushing member 222, and the fixing plate 210 provides the force for the chip 2000 in contact with the fixing plate 210. The chips 2000 abut against each other, and the chip 2000 adjacent to the fixing plate 210 is at the analysis station. After the samples to be analyzed in the chip 2000 at the analysis station are analyzed, the second drive 221 drives the pushing member 222 to move, the chip 2000 at the analysis station is released, and the blocking mechanism 500 moves so that the chip 2000 at the analysis station falls to the recovery station. The blocking mechanism 500 moves to reset, and the second drive 221 drives the pushing member 222 to move again so that the remaining chips 2000 abut against each other, and the next chip 2000 moves to the analysis station. The preceding operations are repeated so that the next chip 2000 is also analyzed and recovered. After all the chips 2000 are analyzed and recovered, the next batch of chips 2000 is placed for analysis and recovery.

Referring to FIG. 5, the baffle 520 is designed to have a rectangular structure, and two sides of the baffle 520 can prevent the chip 2000 from falling. The interior of the baffle 520 is provided with a through cavity 521. When penetrating through the first cavity 110, the upright plate 2222 of the pushing member 222 penetrates through the through cavity 521 of the baffle 520 so that the pushing member 222 can move freely without being affected by the baffle 520.

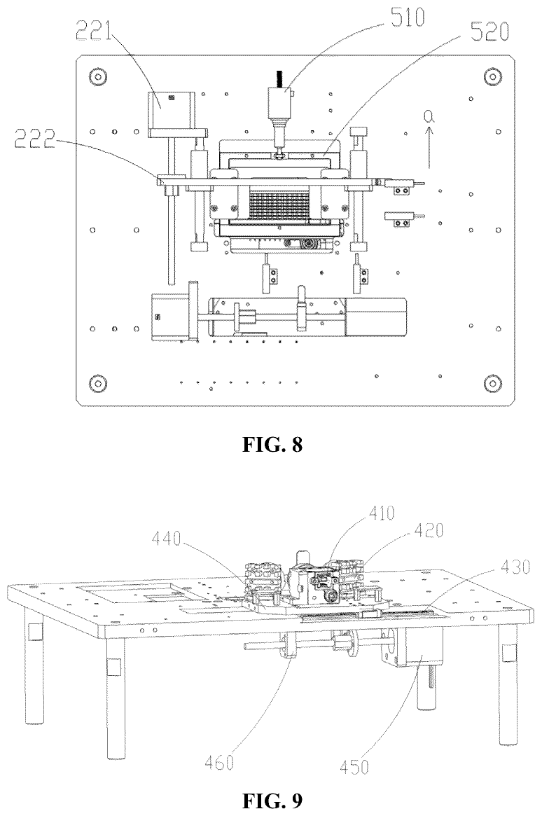

Referring to FIG. 8, a process of discarding the chip 2000 is described in detail. When the chip 2000 is at the analysis station, the second drive 221 drives the pushing member 222 to move in an opposite direction of a direction a so that the chips 2000 abut against each other. The electrophoresis mechanism 300 performs the electrophoretic separation on the samples to be analyzed in the chip 2000 at the analysis station, and the imaging mechanism 400 captures the images of the samples to be analyzed. Then, the second drive 221 drives the pushing member 222 to move in the direction a, the chip 2000 loses the thrust from the pushing member 222, and the first drive 510 drives the baffle 520 to move in the direction a so that the chip 2000 falls to the recovery station.

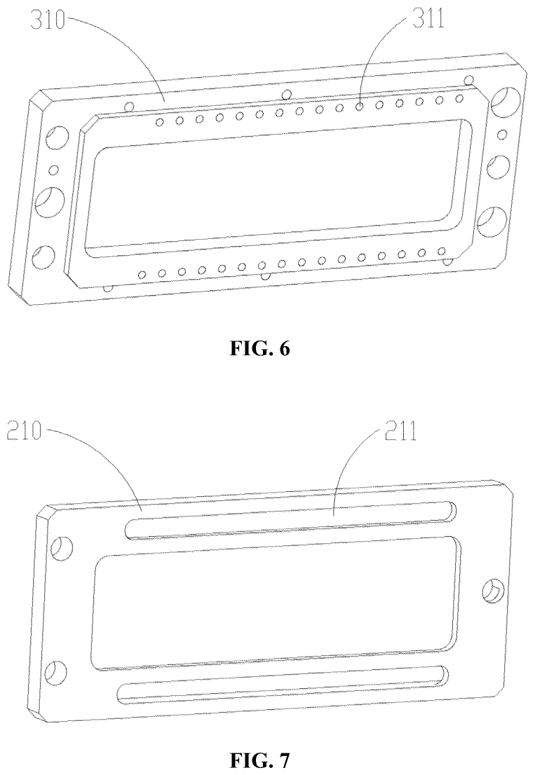

In some specific embodiments of the present application, referring to FIG. 7, the fixing plate 210 includes through holes 211 disposed on a first side and a second side. Referring to FIG. 6, the electrophoresis mechanism 300 includes an electrophoretic fixing plate 310 and probes, the electrophoretic fixing plate 310 is disposed adjacent to the fixing plate 210, the electrophoretic fixing plate 310 includes probe holes 311 for accommodating the probes and disposed on a first side and a second side, and the probe holes 311 correspond to the through holes 211.

In some embodiments, the first side and the second side of the fixing plate 210 are the upper side and the lower side of the fixing plate 210, respectively, and the first side and the second side of the electrophoretic fixing plate 310 are the upper side and the lower side of the electrophoretic fixing plate 310, respectively.

The electrophoretic fixing plate 310 is fixedly disposed on the baseplate 100 and adjacent to the fixing plate 210. The probes are fixedly disposed in the probe holes 311 on the first side and the second side of the electrophoretic fixing plate 310 and penetrate through the through holes 211 on the first side and the second side of the fixing plate 210.

When the chip 2000 is at the analysis station, the probes contact the chip 2000 and apply the voltages to the chip 2000 so that the samples to be analyzed in the chip 2000 are subjected to the electrophoretic separation.

In some specific embodiments of the present application, referring to FIG. 9, the imaging mechanism 400 includes a camera 410 disposed on the baseplate 100 and at least one light source 420 disposed on the baseplate 100.

When the chip 2000 is at the analysis station, the electrophoresis mechanism 300 performs the electrophoretic separation on the samples to be analyzed in the chip 2000. After the electrophoretic separation, the light source 420 provides light, and the camera 410 captures the images of the samples to be analyzed in the chip 2000. After the images of the samples to be analyzed are obtained, the images are analyzed.

In this embodiment, two light sources 420 are provided, which emit light of different wavelengths. In some embodiments, one light source 420 emits light of a first wavelength to excite first optically detectable labels on the nucleic acid samples to produce first optical signals, and the camera 410 captures the nucleic acid samples to collect the first optical signals for imaging; and the other light source 420 emits light of a second wavelength to excite second optically detectable labels on the ladder to produce second optical signals, and the camera 410 captures the ladder to collect the second optical signals for imaging. The first optically detectable labels may be the same as or different from the second optically detectable labels.

In some specific embodiments of the present application, referring to FIGS. 9 and 10, the baseplate 100 is provided with a second cavity 120, and the imaging mechanism 400 includes a first guide rail 430 disposed on the baseplate 100, a carrier plate 440 disposed on the first guide rail 430, a third drive 450 disposed under the baseplate 100, and a connecting plate 460 with an end connected to the third drive 450 and the other end penetrating through the second cavity 120 and connected to the carrier plate 440. Being driven by the third drive 450, the connecting plate 460 drives the carrier plate 440 to move on the first guide rail 430. The camera 410 and the light source 420 are disposed on the carrier plate 440.

The third drive 450 may drive the connecting plate 460 to move. For example, the third drive 450 is an electric motor, and an output shaft of the electric motor is connected to the connecting plate 460. When the electric motor operates, the output shaft drives the connecting plate 460 to move.

To save space, the third drive 450 is disposed under the baseplate 100.

A slider may be disposed on the first guide rail 430, and the carrier plate 440 is disposed on the slider. When the third drive 450 drives the carrier plate 440 to move, the carrier plate 440 drives the slider to move on the first guide rail 430.

The third drive 450 drives the connecting plate 460 to move, the connecting plate 460 drives the carrier plate 440 to move on the first guide rail 430, and the carrier plate 440 drives the camera 410 and the light source 420 to move so that the camera 410 captures different positions of the chip 2000.

In this embodiment, the chip 2000 is provided with multiple electrophoresis channels, and each electrophoresis channel can accommodate one sample to be analyzed. For example, if 16 electrophoresis channels are disposed, 16 samples to be analyzed are correspondingly accommodated. The electrophoretic fixing plate 310 is provided with two probes above and below each electrophoresis channel, respectively. For example, 32 probes are disposed in total. These probes may simultaneously perform the electrophoretic separation on the samples to be analyzed within the electrophoresis channels. After the electrophoretic separation, the camera 410 captures images of samples to be analyzed within some electrophoresis channels, for example, three electrophoresis channels. Being driven by the third drive 450, the camera 410 moves and captures images of samples to be analyzed within some other electrophoresis channels, for example, another three electrophoresis channels. As described above, the camera 410 moves multiple times to capture the images of all the samples to be analyzed, which are subjected to the electrophoretic separation, so as to complete the analysis of all the samples to be analyzed.

Due to a limited imaging range of the camera 410, the carrier plate 440 is moved through the third drive 450, and the camera 410 is also moved, ensuring that the camera 410 can capture the image of the sample to be analyzed within each electrophoresis channel.

In some specific embodiments of the present application, referring to FIGS. 1, 3, and 10, the analysis device further includes a sample loading mechanism 600, and the sample loading mechanism 600 includes a sample reservoir 610 and a sample loading assembly for drawing the samples to be analyzed from the sample reservoir 610 and loading the samples to be analyzed into the chip 2000.

The sample reservoir 610 is disposed on the baseplate 100 and includes a sample storage base and a multi-well plate disposed on the sample storage base. For example, the multi-well plate is a 96-well plate.

The sample loading assembly moves to a corresponding position of a sample to be analyzed on the multi-well plate, draws the sample to be analyzed, moves to a corresponding position of the chip 2000, and loads the sample to be analyzed into an electrophoresis channel of the chip 2000. The sample loading assembly can load the samples to be analyzed into different electrophoresis channels of the chip 2000 by operating multiple times.

In some specific embodiments of the present application, referring to FIGS. 1, 3, and 10, the sample loading assembly includes a sample loader 621, a first driving assembly 622, a second driving assembly 623, and a third driving assembly 624.

The sample loader 621 is disposed on the first driving assembly 622, and the first driving assembly 622 drives the sample loader 621 to move in a first direction.

The first driving assembly 622 is disposed on the second driving assembly 623, and the second driving assembly 623 drives the first driving assembly 622 to move in a second direction. The second driving assembly 623 is disposed on the third driving assembly 624, and the third driving assembly 624 drives the second driving assembly 623 to move in a third direction.

The first direction is a direction z shown in FIG. 1, the second direction is a direction y shown in FIG. 1, and the third direction is a direction x shown in FIG. 1.

The third driving assembly 624 drives the second driving assembly 623 to move in the third direction. The first driving assembly 622 is disposed on the second driving assembly 623, and the sample loader 621 is disposed on the first driving assembly 622 so that the first driving assembly 622 and the sample loader 621 move in the third direction. The second driving assembly 623 drives the first driving assembly 622 to move in the second direction so that the sample loader 621 moves in the second direction. The first driving assembly 622 drives the sample loader 621 to move in the first direction. Thus, the sample loader 621 moves in the first direction, the second direction, and the third direction so that the sample loader 621 can smoothly complete sample loading.

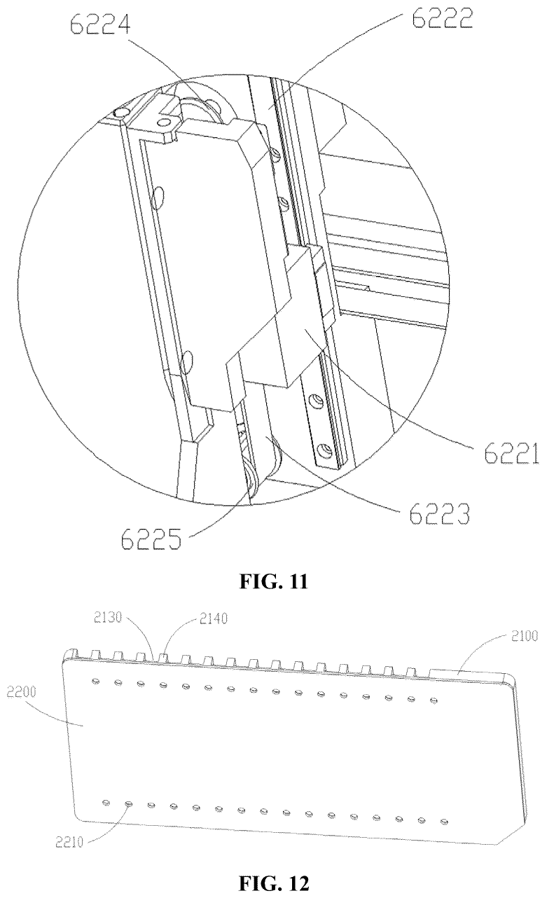

In some specific embodiments of the present application, referring to FIGS. 10 and 11, the first driving assembly 622 includes a first moving plate 6221, a second guide rail 6222, a first synchronous belt 6223, a first driving wheel 6224, a first driven wheel 6225, and a fourth drive 6226, the second driving assembly 623 includes a second moving plate 6231, a third guide rail 6232, a second synchronous belt 6233, a second driving wheel 6234, a second driven wheel 6235, and a fifth drive 6236, and the third driving assembly 624 includes a fourth guide rail 6241, a third synchronous belt 6242, a third driving wheel 6243, a third driven wheel 6244, and a sixth drive 6245.

Two fourth guide rails 6241 are disposed on two sides of the baseplate 100 one to one, the second moving plate 6231 is disposed on the two fourth guide rails 6241 and fixedly connected to the third synchronous belt 6242, the third synchronous belt 6242 is disposed around the third driving wheel 6243 and the third driven wheel 6244, the third driving wheel 6243 and the third driven wheel 6244 are disposed on the baseplate 100, and the sixth drive 6245 is drivingly connected to the third driving wheel 6243; the third guide rail 6232 is disposed on the second moving plate 6231, the first moving plate 6221 is disposed on the third guide rail 6232 and fixedly connected to the second synchronous belt 6233, the second synchronous belt 6233 is disposed around the second driving wheel 6234 and the second driven wheel 6235, the second driving wheel 6234 and the second driven wheel 6235 are disposed on the second moving plate 6231, and the fifth drive 6236 is drivingly connected to the second driving wheel 6234; and the second guide rail 6222 is disposed on the first moving plate 6221, the sample loader 621 is disposed on the second guide rail 6222 and fixedly connected to the first synchronous belt 6223, the first synchronous belt 6223 is disposed around the first driving wheel 6224 and the first driven wheel 6225, the first driving wheel 6224 and the first driven wheel 6225 are disposed on the first moving plate 6221, and the fourth drive 6226 is drivingly connected to the first driving wheel 6224.

The fourth drive 6226 may drive the first driving wheel 6224 to rotate. For example, the fourth drive 6226 is an electric motor, and an output shaft of the electric motor is connected to the first driving wheel 6224. When the electric motor operates, the output shaft drives the first driving wheel 6224 to rotate.

The fifth drive 6236 may drive the second driving wheel 6234 to rotate. For example, the fifth drive 6236 is an electric motor, and an output shaft of the electric motor is connected to the second driving wheel 6234. When the electric motor operates, the output shaft drives the second driving wheel 6234 to rotate.

The sixth drive 6245 may drive the third driving wheel 6243 to rotate. For example, the sixth drive 6245 is an electric motor, and an output shaft of the electric motor is connected to the third driving wheel 6243. When the electric motor operates, the output shaft drives the third driving wheel 6243 to rotate.

The fourth drive 6226 in operation transmits power to the first driving wheel 6224, and the first driving wheel 6224 rotates and drives the first synchronous belt 6223 and the first driven wheel 6225 to rotate. Since the sample loader 621 is fixedly connected to the first synchronous belt 6223, the sample loader 621 moves in the first direction.

The fifth drive 6236 in operation transmits power to the second driving wheel 6234, and the second driving wheel 6234 rotates and drives the second synchronous belt 6233 and the second driven wheel 6235 to rotate. Since the first moving plate 6221 is fixedly connected to the second synchronous belt 6233, the first moving plate 6221 moves in the second direction. The sample loader 621 is disposed on the first moving plate 6221 so that the sample loader 621 moves in the second direction.

The sixth drive 6245 in operation transmits power to the third driving wheel 6243, and the third driving wheel 6243 rotates and drives the third synchronous belt 6242 and the third driven wheel 6244 to rotate. Since the second moving plate 6231 is fixedly connected to the third synchronous belt 6242, the second moving plate 6231 moves in the third direction. The first moving plate 6221 is disposed on the second moving plate 6231 so that the second moving plate 6231 and the sample loader 621 move in the third direction.

The sample loader 621 may be fixedly connected to the first synchronous belt 6223 in the following manner: the first synchronous belt 6223 is provided with at least one through hole, and a fastener such as a screw penetrates through the through hole and enters the sample loader 621 so that the sample loader 621 and the first synchronous belt 6223 are fixed to each other.

The first moving plate 6221 may be fixedly connected to the second synchronous belt 6233 in the following manner: the second synchronous belt 6233 is provided with at least one through hole, and a fastener such as a screw penetrates through the through hole and enters the first moving plate 6221 so that the first moving plate 6221 and the second synchronous belt 6233 are fixed to each other.

The second moving plate 6231 may be fixedly connected to the third synchronous belt 6242 in the following manner: the third synchronous belt 6242 is provided with at least one through hole, and a fastener such as a screw penetrates through the through hole and enters the second moving plate 6231 so that the second moving plate 6231 and the third synchronous belt 6242 are fixed to each other.

A slider may be disposed on the second guide rail 6222, and the sample loader 621 is disposed on the slider. When the fourth drive 6226 drives the sample loader 621 to move, the sample loader 621 drives the slider to move on the second guide rail 6222.

A slider may be disposed on the third guide rail 6232, and the first moving plate 6221 is disposed on the slider. When the fifth drive 6236 drives the first moving plate 6221 to move, the first moving plate 6221 drives the slider to move on the third guide rail 6232.

Sliders may be disposed on the fourth guide rails 6241, and the second moving plate 623 1 is disposed on the sliders. When the sixth drive 6245 drives the second moving plate 6231 to move, the second moving plate 6231 drives the sliders to move on the fourth guide rails 6241.

In some specific embodiments of the present application, referring to FIG. 10, the sample loader 621 includes a piercing needle 6211 disposed on the first driving assembly 622 and a sample loading needle 6212 disposed on the first driving assembly 622.

In some specific embodiments of the present application, referring to FIGS. 1 and 3, the sample loading assembly further includes a tip container 630 disposed on the baseplate 100, the tip container 630 is provided with multiple first storage cavities for placing new tips and at least one second storage cavity for placing old tips, and the second storage cavity is provided with a clamping slot, making it convenient for an old tip to be removed from the sample loading needle 6212 and fall to the second storage cavity.

The tip is a pipette tip. After fitted with the tip, the sample loading needle 6212 may draw the sample to be analyzed from the sample reservoir 610 and load the sample to be analyzed into the electrophoresis channel of the chip 2000.

A flow process of the sample loader 621 is described in detail here. When the chip 2000 is at the analysis station, the sample loader 621 moves to above a first storage cavity of the tip container 630. The sample loader 621 moves downward so that the tip is fitted with the sample loading needle 6212. The sample loader 621 moves upward and moves to above the sample reservoir 610. The sample loader 621 moves downward to draw the sample to be analyzed. The sample loader 621 moves upward and moves to above the chip 2000. At this time, the piercing needle 6211 is correspondingly located above the electrophoresis channel of the chip 2000 that needs to be loaded. The sample loader 621 moves downward, the piercing needle 6211 pierces the chip 2000, the sample loader 621 moves upward and slightly moves, and the sample loading needle 6212 is correspondingly located above the pierced electrophoresis channel of the chip 2000. The sample loader 621 moves downward to load the sample to be analyzed into the electrophoresis channel. The sample loader 621 moves upward and moves to above the second storage cavity of the tip container 630. The sample loader 621 moves downward, clamps the tip into the clamping slot, and moves upward so that the tip is removed from the sample loading needle 6212 and falls to the second storage cavity. In other embodiments, the above steps may be interchanged. For example, piercing may be performed firstly, followed by fitting the tip with the sample loading needle 6212, sampling, loading, and removing the tip. Alternatively, the tip may be fitted with the sample loading needle 6212 firstly, followed by piercing, sampling, loading, and removing the tip.

An embodiment of the present invention provides an analysis system. Referring to FIG. 1, the analysis system includes the analysis device according to any one of the preceding embodiments and at least one chip 2000 vertically placed on the chip fixing mechanism 200.

The chip 2000 may be directly placed at the analysis station of the chip fixing mechanism 200. Alternatively, the chip 2000 may be placed at the entrance of the analysis device, and the chip 2000 at the entrance is moved to the analysis station of the chip fixing mechanism 200 by the moving mechanism such as the robotic arm or the conveyor belt. When the chip 2000 is at the analysis station, the chip fixing mechanism 200 fixes the chip 2000 to prevent the chip 2000 from moving during the subsequent electrophoretic separation and imaging of the chip 2000. At this time, the blocking mechanism 500 is at the initial position and can block the chip 2000 and prevent the chip 2000 from falling. After the chip fixing mechanism 200 fixes the chip 2000, the electrophoresis mechanism 300 performs the electrophoretic separation on the samples to be analyzed in the chip 2000. After the electrophoretic separation, the imaging mechanism 400 captures the images of the samples to be analyzed and then analyzes the captured images to obtain the information about the samples to be analyzed, such as fragment lengths, concentrations, and integrity. After the analysis, the chip fixing mechanism 200 releases the chip 2000 and no longer fixes the chip 2000, allowing the chip 2000 to move. The blocking mechanism 500 moves from the initial position, and the chip 2000 falls to the recovery station when not blocked by the blocking mechanism 500. After one chip 2000 is analyzed and recovered, the next chip 2000 is subjected to the preceding operations until all the chips 2000 are analyzed and recovered.

In some specific embodiments of the present invention, referring to FIG. 12, the chip 2000 includes a substrate 2100, the substrate 2100 is provided with multiple electrophoresis channels, and conductive structures 2120 are disposed at two ends of each electrophoresis channel.

Between the conductive structures 2120 at the two ends of the electrophoresis channel, one conductive structure 2120 is a positive electrode conductive structure and one conductive structure 2120 is a negative electrode conductive structure. When the chip 2000 is at the analysis station, the probes of the electrophoresis mechanism 300 contact conductive structures 2120 and generate the voltages applied across the samples within the electrophoresis channels to perform the electrophoretic separation on the samples. After the samples are subjected to the electrophoretic separation, the imaging mechanism 400 captures the images of the samples and then analyzes the captured images. For example, the imaging mechanism 400 analyzes the information about the samples, such as the fragment lengths, concentrations, and integrity.

Since multiple electrophoresis channels are disposed and the conductive structures 2120 are disposed at two ends of each electrophoresis channel, one sample may be loaded into each electrophoresis channel. After the sample is loaded into each electrophoresis channel, multiple samples may be simultaneously subjected to the electrophoretic separation and imaging, thereby greatly improving analysis efficiency.

The substrate 2100 may be made of an inorganic insulating material, an organic insulating material, a polymeric insulating material, a composite material, or a combination thereof. The substrate 2100 may be preferably made of a polypropylene material. The polypropylene material has good light transmittance, does not dissociate ions from its surface in a water environment, and can avoid an electroosmosis effect without surface treatment, so as not to affect the electrophoretic separation process of the samples to be analyzed.

The conductive structure 2120 is an electrode sheet, and the electrode sheet is disposed on the substrate 2100 in a thin-sheet form.

The conductive structure 2120 may be made of graphite. Alternatively, the conductive structure 2120 may be made of another material, for example, a metal such as copper, aluminum, or platinum.

In some specific embodiments of the present invention, referring to FIGS. 12 to 14, the substrate 2100 is provided with a groove 2130 corresponding to a sample loading position of each electrophoresis channel, and a recess direction of the groove 2130 is the same as a direction in which the corresponding electrophoresis channel is disposed.

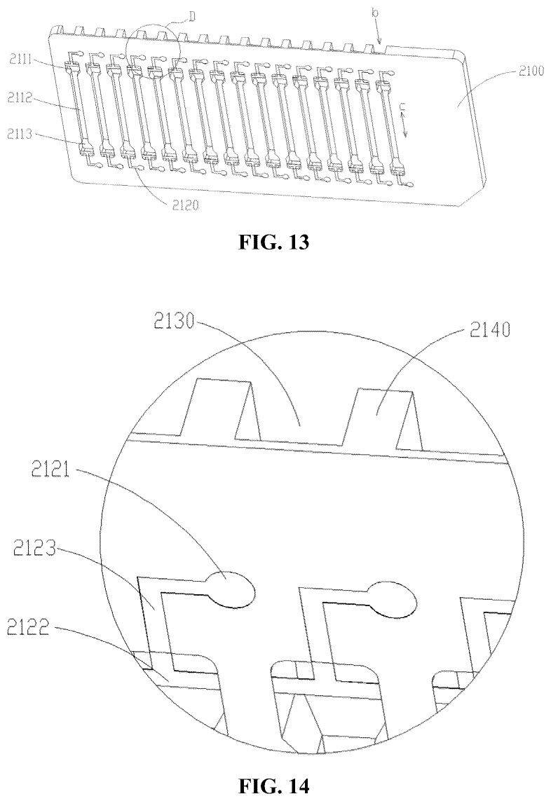

It is to be understood that referring to FIG. 13, a direction b is the recess direction of the groove 2130, and a direction c is the direction in which the electrophoresis channel is disposed, where the direction in which the electrophoresis channel is disposed is a length direction of the electrophoresis channel.

The chip 2000 is placed vertically, and the sample loading position is located above the chip 2000. The piercing needle 6211 of the sample loader 621 pierces the sample loading position, and then the sample loading needle 6212 of the sample loader 621 loads the sample into the electrophoresis channel through the tip.

If the groove 2130 is not correspondingly disposed at the sample loading position of each electrophoresis channel, since the conductive structures 2120 are disposed at two ends of the electrophoresis channel, the substrate 2100 cannot be provided with the electrophoresis channel at the position of the conductive structure 2120 and thus has a certain thickness at the position of the conductive structure 2120. Hindered by the thickness, the piercing needle 6211 needs to penetrate through the thickness, resulting in low sample loading efficiency. Moreover, the thickness has certain hardness, and in the piercing process, the piercing needle 6211 has a risk of deviating from the intended direction and failing to accurately pierce into the electrophoresis channel. In this embodiment, the groove 2130 is correspondingly disposed at the sample loading position of each electrophoresis channel so that the piercing distance of the piercing needle 6211 can be effectively reduced, thereby greatly improving sample loading efficiency and reliability.

Additionally, the chip 2000 is designed to be placed vertically. When a mixed solution of the sample and a loading buffer is loaded into the electrophoresis channel of the chip 2000, glycerol (or lactose) in the loading buffer can increase a sample density and make the sample density greater than the density of the buffer within the electrophoresis channel so that the sample is settled to the proximity of the upper surface of gel. In the other aspect, a low voltage (typically 10 V and lasting for 10 seconds) may be applied to the conductive structures before electrophoresis starts so that the sample accumulates in the proximity of the upper surface of the gel. After the sample is subjected to the electrophoresis, the width of a band separated after the electrophoresis can be compressed, and the number of theoretical plates can be increased, achieving relatively good analysis results, which are impossible for a horizontally placed chip 2000.

In some specific embodiments of the present invention, referring to FIGS. 13 and 14, the conductive structure 2120 includes a contact end 2121, a touch end 2122, and a connecting end 2123 connecting the contact end 2121 to the touch end 2122, the touch end 2122 contacts the corresponding electrophoresis channel, and the contact end 2121 is disposed on a boss 2140 formed between two adjacent grooves 2130.

A probe of the electrophoresis mechanism 300 contacts the contact end 2121, and the contact end 2121 transmits electricity through the connecting end 2123 to the touch end 2122 so that the conductive structures 2120 apply a voltage across the sample within the electrophoresis channel.

In this embodiment, the contact end 2121 is disposed on the boss 2140 formed between two adjacent grooves 2130. In the substrate 2100, structural strength and rigidity at the boss 2140 are greater than structural strength and rigidity at the groove 2130 so that when the probe contacts the contact end 2121 and exerts a force on the contact end 2121, the substrate 2100 can be prevented from deformation or damages.

In some specific embodiments of the present invention, referring to FIG. 13, the electrophoresis channel includes an intermediate channel 2112 and a first channel 2111 and a second channel 2113 that are disposed at two ends of the intermediate channel 2112.

The centerline of the intermediate channel 2112 is a straight line, and the first channel 2111 and the second channel 2113 are disposed at two ends of the centerline of the intermediate channel 2112.

The intermediate channel 2112 is filled with the gel and the buffer. If the first channel 2111 contacts the negative electrode conductive structure and the second channel 2113 contacts the positive electrode conductive structure, the first channel 2111 serves as a liquid inlet channel, the sample loading position is disposed on the liquid inlet channel, and the second channel 2113 serves as a liquid storage channel. The sample is loaded into the first channel 2111. When the probes of the electrophoresis mechanism 300 contact the conductive structures 2120 and generate a voltage applied across the sample within the first channel 2111, the sample moves from the first channel 2111 towards the second channel 2113 under the action of the electric field. The gel has a porous structure and may serve as a sieving medium, and the buffer maintains a degree of dissociation so that sample fragments of different lengths are separated at different speeds. The sample fragments of different lengths form bands within the electrophoresis channel, completing the electrophoretic separation. If the first channel 2111 contacts the positive electrode conductive structure and the second channel 2113 contacts the negative electrode conductive structure, the first channel 2111 serves as the liquid storage channel and the second channel 2113 serves as the liquid inlet channel. The sample is loaded into the second channel 2113. When the probes of the electrophoresis mechanism 300 contact the conductive structures 2120 and generate the voltage applied across the sample within the second channel 2113, the sample moves from the second channel 2113 towards the first channel 2111 under the action of the electric field. The gel has the porous structure and may serve as the sieving medium, and the buffer maintains the degree of dissociation so that the sample fragments of different lengths are separated at different speeds. The sample fragments of different lengths form the bands within the electrophoresis channel, completing the electrophoretic separation.

The gel may be agarose gel. The gel may be another gel, such as polyacrylamide gel.

The buffer may be a tris-acetate-EDTA (TAE) buffer. The buffer may be another buffer, such as a 3-(N-morpholino)propanesulfonic acid (MOPS) buffer or a tris-borate-EDTA (TBE) buffer.

In some specific embodiments of the present invention, referring to FIGS. 13 and 14, in a direction perpendicular to a line connecting the center of the first channel 2111, the center of the intermediate channel 2112, and the center of the second channel 2113, a cross-sectional width of the first channel 2111 and a cross-sectional width of the second channel 2113 are greater than a cross-sectional width of the intermediate channel 2112, facilitating the movement of the sample within the first channel 2111 to the intermediate channel 2112 or the movement of the sample within the second channel 2113 to the intermediate channel 2112 during the electrophoresis (which depends on whether the first channel 2111 or the second channel 2113 serves as the liquid inlet channel).

In some specific embodiments of the present invention, referring to FIGS. 13 and 14, in the direction perpendicular to the line connecting the center of the first channel 2111, the center of the intermediate channel 2112, and the center of the second channel 2113, a cross-sectional width of the touch end 2122 is greater than or equal to the cross-sectional width of the first channel 2111 and the cross-sectional width of the second channel 2113. Thus, a sufficiently large electric field can be applied to the sample within the first channel 2111 or the sample within the second channel 2113 (which depends on whether the first channel 2111 or the second channel 2113 serves as the liquid inlet channel), thereby ensuring that the sample within the first channel 2111 or the sample within the second channel 2113 successfully moves to the intermediate channel 2112.

In some specific embodiments of the present invention, referring to FIG. 12, the chip 2000 further includes a cover plate 2200 disposed on the substrate 2100, and the cover plate 2200 is made of a transparent material.

The cover plate 2200 made of the transparent material can ensure that the imaging mechanism 400 can smoothly obtain clear images when capturing the images of the samples, avoiding blurred images due to the cover plate 2200.

The conductive structures 2120 may be disposed on the cover plate 2200 and correspond to the electrophoresis channel. Specifically, the conductive structure 2120 may be entirely disposed on the cover plate 2200, with the touch end 2122 contacting the first channel 2111 or the second channel 2113. Alternatively, the conductive structures 2120 may be disposed on the substrate 2100 and correspond to the electrophoresis channel. Specifically, the contact end 2121 is disposed on the substrate 2100, the connecting end 2123 and the touch end 2122 extend to the first channel 2111 or the second channel 2113, and the touch end 2122 contacts the first channel 2111 or the second channel 2113.

After the probe contacts the contact end 2121, the contact end 2121 conducts electricity to the touch end 2122 through the connecting end 2123. The touch end 2122 contacts a mixed solution of the sample to be analyzed, the gel, and the buffer within the first channel 2111 or the second channel 2113 to conduct electricity to the mixed solution so that the conductive structures 2120 apply the voltage to the sample to be analyzed.

The cover plate 2200 may be made of an inorganic insulating material, an organic insulating material, a polymeric insulating material, a composite material, or a combination thereof. The cover plate 2200 may be preferably made of the polypropylene material. The polypropylene material has good light transmittance, does not dissociate ions from its surface in the water environment, and can avoid the electroosmosis effect without surface treatment, so as not to affect the electrophoretic separation process of the samples to be analyzed.

In some specific embodiments of the present invention, referring to FIG. 12, the cover plate 2200 is provided with a piercing hole 2210 corresponding to the contact end 2121. The piercing hole 2210 is disposed so that the probe can penetrate through the piercing hole 2210 and contact the conductive structure 2120 to smoothly apply the voltage to the sample. Moreover, the piercing hole 2210 can implement a certain positioning function and prevent the probe from moving to a wrong position.

In the description of the specification, the description with reference to terms such as “an embodiment”, “some embodiments”, “an illustrative embodiment”, “an example”, “some examples”, “specific examples”, and “embodiments” is intended to mean that specific characteristics, structures, materials, or features described in conjunction with such embodiment or example are included in at least one embodiment or example of the present invention. In the specification, the illustrative descriptions of the preceding terms do not necessarily refer to the same embodiments or examples. Moreover, the described specific characteristics, structures, materials, or features may be combined appropriately in any one or more embodiments or examples.

The embodiments of the present invention have been illustrated and described above. It is to be understood that the preceding embodiments are exemplary and cannot be construed as limiting the present invention. Those of ordinary skill in the art can make changes, modifications, substitutions, and variations to the preceding embodiments within the scope of the present invention.

1. An analysis device, comprising:
a baseplate provided with a first cavity;
a chip fixing mechanism disposed on the baseplate and comprising at least one analysis station located in the first cavity;
an electrophoresis mechanism disposed on the baseplate and an imaging mechanism disposed on the baseplate; and
a blocking mechanism disposed in the first cavity, corresponding to a position of an analysis station among the at least one analysis station, and comprising at least one recovery station;
wherein when a chip is located at the analysis station, the chip fixing mechanism fixes the chip, the blocking mechanism prevents the chip from falling, the electrophoresis mechanism performs electrophoretic separation on samples to be analyzed in the chip, the imaging mechanism captures images of the samples to be analyzed, and finally the chip fixing mechanism releases the chip and the blocking mechanism moves so that the chip falls to a recovery station among the at least one recovery station.

2. The analysis device according to claim 1, wherein the blocking mechanism comprises:
a baffle disposed in the first cavity and corresponding to the position of the analysis station; and
a first drive drivingly connected to the baffle.

3. The analysis device according to claim 2, wherein the blocking mechanism further comprises a bending plate having a certain bending angle, disposed in the first cavity, and corresponding to the position of the analysis station, wherein when the chip falls, the chip falls to the recovery station along the bending plate.

4. The analysis device according to claim 1, wherein the chip fixing mechanism comprises:
a fixing plate disposed on the baseplate; and
a pushing mechanism providing a thrust towards the chip placed on the fixing plate, wherein being pushed by the pushing mechanism, the chip abuts against the fixing plate.

5. The analysis device according to claim 4, wherein the pushing mechanism comprises:
a second drive disposed under the baseplate; and
a pushing member comprising a transverse plate and an upright plate, wherein the transverse plate is drivingly connected to the second drive, an end of the upright plate is fixedly connected to the transverse plate, and another end of the upright plate penetrates through the first cavity and contacts the chip placed on the fixing plate.

6. The analysis device according to claim 4, wherein the fixing plate comprises through holes disposed on a first side and a second side, the electrophoresis mechanism comprises an electrophoretic fixing plate and probes, the electrophoretic fixing plate is disposed adjacent to the fixing plate, the electrophoretic fixing plate comprises probe holes for accommodating the probes and disposed on a first side and a second side, and the probe holes correspond to the through holes.

7. The analysis device according to claim 1, wherein the baseplate is provided with a second cavity, and the imaging mechanism comprises a first guide rail disposed on the baseplate, a carrier plate disposed on the first guide rail, a third drive disposed under the baseplate, and a connecting plate with an end connected to the third drive and another end penetrating through the second cavity and connected to the carrier plate, wherein being driven by the third drive, the connecting plate drives the carrier plate to move on the first guide rail.

8. The analysis device according to claim 7, wherein the imaging mechanism further comprises a camera disposed on the carrier plate and a light source disposed on the carrier plate.

9. The analysis device according to claim 1, further comprising a sample loading mechanism comprising a sample reservoir and a sample loading assembly for drawing the samples to be analyzed from the sample reservoir and loading the samples to be analyzed into the chip.

10. The analysis device according to claim 9, wherein the sample loading assembly comprises:
a sample loader;
a first driving assembly, wherein the sample loader is disposed on the first driving assembly, and the first driving assembly drives the sample loader to move in a first direction;
a second driving assembly, wherein the first driving assembly is disposed on the second driving assembly, and the second driving assembly drives the first driving assembly to move in a second direction; and
a third driving assembly, wherein the second driving assembly is disposed on the third driving assembly, and the third driving assembly drives the second driving assembly to move in a third direction.

11. The analysis device according to claim 10, wherein the first driving assembly comprises a first moving plate, a second guide rail, a first synchronous belt, a first driving wheel, a first driven wheel, and a fourth drive, the second driving assembly comprises a second moving plate, a third guide rail, a second synchronous belt, a second driving wheel, a second driven wheel, and a fifth drive, and the third driving assembly comprises a fourth guide rail, a third synchronous belt, a third driving wheel, a third driven wheel, and a sixth drive; wherein two fourth guide rails are disposed on two sides of the baseplate one to one, the second moving plate is disposed on the two fourth guide rails and fixedly connected to the third synchronous belt, the third synchronous belt is disposed around the third driving wheel and the third driven wheel, the third driving wheel and the third driven wheel are disposed on the baseplate, and the sixth drive is drivingly connected to the third driving wheel; the third guide rail is disposed on the second moving plate, the first moving plate is disposed on the third guide rail and fixedly connected to the second synchronous belt, the second synchronous belt is disposed around the second driving wheel and the second driven wheel, the second driving wheel and the second driven wheel are disposed on the second moving plate, and the fifth drive is drivingly connected to the second driving wheel; and the second guide rail is disposed on the first moving plate, the sample loader is disposed on the second guide rail and fixedly connected to the first synchronous belt, the first synchronous belt is disposed around the first driving wheel and the first driven wheel, the first driving wheel and the first driven wheel are disposed on the first moving plate, and the fourth drive is drivingly connected to the first driving wheel.

12. An analysis system, comprising:
the analysis device according to claim 1; and
at least one chip vertically placed on the chip fixing mechanism.

13. The analysis system according to claim 12, wherein a chip among the at least one chip comprises a substrate, the substrate is provided with a plurality of electrophoresis channels, and for each electrophoresis channel among the plurality of electrophoresis channels, conductive structures are disposed at two ends of the electrophoresis channel.

14. The analysis system according to claim 13, wherein the substrate is provided with a groove corresponding to a sample loading position of the electrophoresis channel, and a recess direction of the groove is the same as a direction in which the corresponding electrophoresis channel is disposed.

15. The analysis system according to claim 14, wherein each of the conductive structures comprises a contact end, a touch end, and a connecting end connecting the contact end to the touch end, the touch end contacts the corresponding electrophoresis channel, and the contact end is disposed on a boss formed between two adjacent grooves.

16. The analysis system according to claim 15, wherein the electrophoresis channel comprises an intermediate channel and a first channel and a second channel that are disposed at two ends of the intermediate channel.

17. The analysis system according to claim 16, wherein in a direction perpendicular to a line connecting a center of the first channel, a center of the intermediate channel, and a center of the second channel, a cross-sectional width of the first channel and a cross-sectional width of the second channel are greater than a cross-sectional width of the intermediate channel.

18. The analysis system according to claim 16, wherein in a direction perpendicular to a line connecting a center of the first channel, a center of the intermediate channel, and a center of the second channel, a cross-sectional width of the touch end is greater than or equal to a cross-sectional width of the first channel and a cross-sectional width of the second channel.

19. The analysis system according to claim 15, wherein the chip further comprises a cover plate disposed on the substrate, and the cover plate is made of a transparent material.

20. The analysis system according to claim 19, wherein the cover plate is provided with a piercing hole corresponding to the contact end.
